(19) United States
(12) Patent Application Publication
(10) Pub. No.: US 2010/0281475 A1
(43) Pub. Date: Nov. 4, 2010

(54) SYSTEM AND METHOD FOR MOBILE SMARTPHONE APPLICATION DEVELOPMENT AND DELIVERY

(75) Inventors: Shailendra Jain, New Brighton, MN (US); Andrew Lunstad, North Oaks, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: MOBILE ON SERVICES, INC., Minneapolis, MN (US)

(21) Appl. No.: 12/773,296

(22) Filed: May 4, 2010

Related U.S. Application Data
(60) Provisional application No. 61/175,251, filed on May 4, 2009.

(51) Int. Cl. G06F 9/44

(52) U.S. Cl. 717/172

(57) ABSTRACT

Various embodiments of the disclosed invention include a design and development interface for mobile smartphone applications; the generation and delivery of content customized to the smartphone application execution platform; and the support of update functionality within the mobile applications. In one embodiment, a development environment provides templates via a website interface to easily create and design a smartphone application. This design interface can also be used to create updates for deployed smartphone applications. Within the mobile application, the application content is provided by XML data sets and non-textual data (such as images), and displayed within a set of modifiable containers. These containers and the data displayed within the containers may be updated and modified, enabling full customization of the application and its displayed content.

### CROSS-REFERENCE TO RELATED APPLICATIONS

This application claims priority to U.S. provisional application Ser. No. 61/175,251, filed May 4, 2009, entitled “SYSTEM AND METHOD FOR MOBILE SMARTPHONE APPLICATION DEVELOPMENT AND DELIVERY,” which is hereby incorporated by reference in its entirety.

### FIELD OF THE INVENTION

The field of the present invention generally relates to the use of mobile computing devices. The field of the present invention more specifically relates to the development and implementation of internet-connected applications operating within smartphone software environments.

### BACKGROUND OF THE INVENTION

Consumer and business users increasingly rely on smartphones as their primary lifestyle and productivity tool. Devices such as the Blackberry and iPhone smartphone environments provide millions of users with access to mobile, internet-connected content through standardized operating platforms. Accordingly, content providers have attempted to reach mobile smartphone users with content delivered through the internet directly to these mobile devices. This is primarily performed in the form of mobile websites, which are typically scaled-down versions of content available via traditional websites designed for non-mobile computing devices.

One shortcoming of mobile websites is that content must be specifically requested within each webpage, which in turn requires a command from the user to download the page as it is being accessed. This is often accompanied by delay as each new piece of data must be downloaded via bandwidth-variable mobile networks. Further, many mobile websites forego significant branding and graphics in order to provide a fast-to-render mobile web experience.

A much more permanent and robust solution for the delivery of content is through an application running on the smartphone which directly contains the data and data applications originating from a content provider. However, there are numerous hurdles to the delivery of content through mobile smartphone applications. Each mobile platform contains its own operating environment, requiring separate programming or compilation. Further, the content programmed within mobile phone applications is typically hard-wired into the application and is not subject to modification.

With respect to the creation of smartphone applications, existing solutions in the art provide limited capabilities to address the practical hurdles encountered in their design, updating, and deployment. Various application development solutions enable the ability to create a smartphone application that can be ported to multiple platforms, or enable the ability to create the application once and have it run on multiple smartphone devices. Some application development solutions, however, require the use of specific development languages and tools. For example, current licensing restrictions for applications deployed in the Apple App Store require the use of Apple-approved APIs and programming languages.

Other mobile application solutions (such as the PhoneGap development platform) convert content written in markup language, such as HTML and Javascript, into mobile applications. These techniques fail, however, to provide a content provider with flexibility to change both the format of the application and the data within the application. To fully change the format and the data of the application content, content providers will need to provide hard-wired update functionality, or may even be required to redeploy the entire application to end users.

In a similar field, the capabilities of using design templates and other point-and-click approaches to create non-mobile websites are well known in the art. However, a non-mobile web page is not useful on a smartphone device, and the basic markup language generated for a web page is far simpler than the detailed design requirements for an application on numerous smartphone platforms.

What is needed in the art is functionality to not only easily supply and develop mobile smartphone applications, but functionality to store easy-to-use data within an application on the smartphone, dynamically update the application according to changes desired by the content provider, and provide responsive input from the application to the content provider. Each of these enhanced features is enabled by the various embodiments of the present invention disclosed herein.

### BRIEF SUMMARY OF THE INVENTION

The various disclosed embodiments of the present invention include systems and methods used for the development and delivery of mobile smartphone applications (interchangeably referred to as “mobile applications”, “smartphone applications”, or simply “applications”). These smartphone applications may be executed upon a wide variety of mobile devices and operating platforms, and deployed to any number of users or subscribers. The developed smartphone applications may be designed by a content provider to contain specific data and functionality, and provide portability to mobile devices for numerous types of data within a wide variety of formats. The smartphone applications described herein typically comprise self-contained software that is installed on a mobile device, and are primarily used for the interactive display of predefined content, similar to that of a website interface.

One aspect of the present invention provides for the enhanced compilation and development of a mobile application for mobile devices, the application distributed to each mobile device user through the use of mobile deployment packages. A mobile deployment package, typically in the form of an executable installation program specific to a smartphone operating system, contains a number of application-specific components, including images, forms, and data for any relevant settings and preferences.

An additional aspect of the present invention enables a content provider to provide design, customization, updates, and other input to the launched applications via a user-friendly graphical user interface (GUI). In one embodiment, this GUI comprises a website which provides for design and testing of the mobile application before its compilation and distribution. The GUI simulates the mobile platform and allows a walk-through of the designed application. The mobile application can be designed through the use of templates and an easy-to-use editor. The development website further enables streamlined creation of the application, by compiling and packaging the application into the appropriate format for the mobile device, and potentially distributing the application to targeted smartphone users. The contents of the application can be updated at a later time through this development interface, with relevant updates to the application format or application data provided to the mobile device users as necessary.

An additional aspect of the present invention relates to update functionality directed towards the format and data of applications that are already deployed upon user mobile devices. In one embodiment, the application distributed to users contains one or more containers. These containers are initially designed to contain images and text according to the design specifications of the content provider. Within the containers, one or more “micro” applications are contained. In one embodiment, upon the availability of an update, the mobile application is configured to manually or automatically update the content of the application, including the containers and the micro applications placed within the containers. Therefore, updates not only can be specified for the data within the application, but the entire display of the data itself within the application can be changed. Numerous combinations are possible to update or regenerate the entire mobile application, thereby enabling the application to “morph” into an application with entirely different format and/or content.

In one specific embodiment disclosed herein, a method for deploying and updating software applications on mobile computing devices includes creating design and content of a software application user interface for deployment to a plurality of mobile computing devices. As described herein, this design and content may be designed through use of a remotely accessible website and web service or other development interface. Next, the design and content is converted into a data package, the data package including XML and binary data representing what will be included in the software application user interface. The XML, for example, may include forms, settings and preferences, and data sources, and the binary data may include images.

The data package is then integrated into a native software application executable within a mobile computing device operating system. This is done to embody the software application user interface in a format native to an operating system of the mobile computing device. The native software application may then be deployed to a mobile computing device for installation and execution within its operating system.

Updates to the design and content of the user interface may be provided by updating the XML or binary data within the data package, again which may be through use of the development website and web service. This data package update is deployed to the mobile computing device, and results in an update to the design and content of the user interface without reinstallation of the native application. In further embodiments, this update may be initiated by the user or automatically. The update may be transmitted through an internet connection or through a mobile communications network. Additional embodiments enable integration of the same data package into a plurality of distinct mobile device operating systems (such as different smartphone platforms), and digitally signing the software application prior to deploying the application to the device.

Other specific embodiments of the invention include a mobile communications system, including a mobile communications network, a plurality of mobile devices, a mobile application development computing system, and instructions executed within the mobile application development computing system deploying and updating software applications on the mobile devices as described herein. Additionally, another specific embodiment of the invention provides for a computer program product for deploying and updating software applications on a mobile device through use of a mobile application development platform, with the computer program product comprising a computer readable storage medium having computer readable program code embodied therewith to implement the techniques described herein.

### BRIEF DESCRIPTION OF THE DRAWINGS

FIG. 1 depicts an example development and deployment of a mobile smartphone applications in accordance with one embodiment of the present invention;

FIG. 2 depicts an example operation for designing and publishing a mobile smartphone application to a plurality of consumers in accordance with one embodiment of the present invention;

FIG. 3 depicts an example application framework used for the creation and maintenance of a mobile smartphone application in accordance with one embodiment of the present invention;

FIG. 4 depicts an example application development framework used for the design, deployment, update, and support of mobile smartphone applications in accordance with one embodiment of the present invention;

FIG. 5 depicts screenshots of an example application operating on a smartphone developed with an application development framework in accordance with one embodiment of the present invention; and

FIG. 6 depicts screenshots of an example application operating on a touchscreen smartphone developed with an application development framework in accordance with one embodiment of the present invention.

### DETAILED DESCRIPTION OF THE INVENTION

The various embodiments of the present invention enable the enhanced design, development, deployment, use, and update of mobile software applications. Mobile software applications are executable programs which contain content and run natively on the smartphone device, as opposed to web applications which operate within another piece of software (such as a web browser) and require the download of data. A resident software application provides features not readily available in a mobile web application, including the customized display and format of content and its display interface, the ability for a content consumer to access content even when the device is offline, and the storage of an entire collection of content on a device.

Various embodiments of the present invention include an application development framework for mobile applications. The disclosed mobile application development framework enables content providers to easily and dynamically design mobile applications, customized to the content or other requirements. Through use of the various templates provided within the development environment, no specific development or coding expertise is required. In some embodiments, the entire process of creating a mobile application, from the application layout design to the compilation of content into an executable, can be entirely performed via a point and click interface.

Various embodiments also enable the ability to store data locally (i.e., on the smartphone). Once downloaded, the data is available for present or future usage, and the amount of data accessible is only limited according to bandwidth, storage, and processing capabilities of the mobile device. This is in significant advantage to data used in mobile web applications, which must be consistently downloaded from a server, even if to only obtain a small amount of data.

Further, various embodiments enable the ability to change the shape of the mobile application dynamically, on the fly, without requiring a new application to be downloaded or installed. This feature is performed through the use of a plurality of containers and a plurality of data sets which comprise the mobile application. The containers may be changed through an update by the data provider, such that the format of portions or the entire container may be modified. Likewise, various embodiments enable the ability to change the content displayed within the application dynamically. Definitions for update behavior may be provided to dynamically supply various update elements throughout the mobile application.

The various embodiments disclosed herein also enable the ability to supply input from a mobile application back to a targeted destination. The mobile application may retrieve data from the input or request either with a specific request, or during a data update performed at a later time. Additional functionality related to this and other features is described below with regards to the development, use, and maintenance of the mobile applications.

Mobile Application Development

In one embodiment, a built-it-yourself application development environment may be deployed to provide a user (i.e., a content provider) with a GUI means to construct a native smartphone application without having any knowledge of smartphone development or having code development expertise. The built-it-yourself development environment allows users to use a hosted web service to define the shape of the application and its contents. The ultimate contents of the mobile application are likely to include a variety of data feeds, text items, images which may be zoomed, panned, scrolled, and other items that are displayed or interacted with in the mobile application interface. Dynamic features are presented through an interface of the development environment to allow a fully functional application to be created and customized.

For example, as part of the mobile development environment, the content provider can define how often the application may update its data feeds to change the content and format of the application. As further discussed below, the data feeds contain content data as well as application modifiers. Content data simply provides the contents that need to be displayed in the application. Modifiers actually provide a new shape to the application so the application behavior and look and feel can change dynamically.

The goal of the built-it-yourself development tool is to enable a mobile application to be only designed once, while producing many smartphone applications for the various types of smartphone operating platforms. Further, the built-it-yourself development tool removes all the technical details of how to package data into applications for the various smartphone platforms. For example, a user may use a templated form within the development application to automatically take a well-known content format, such an RSS feed, and turn it into a form and data source for the application to be automatically updated.

The development environment, as further demonstrated in the following description and drawings, runs on a flexible and accessible architecture, enabling the design, deployment, and maintenance of numerous variations of smartphone applications.

Development and Deployment Process

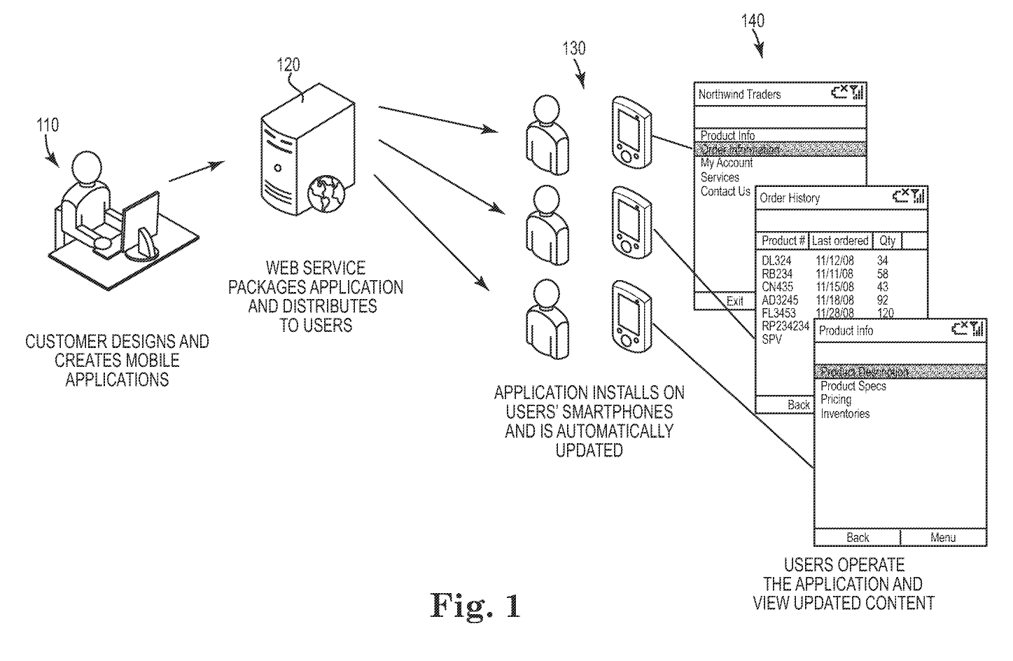

FIG. 1 depicts an example process for developing and distributing mobile applications to a plurality of mobile device users according to one embodiment of the present invention. As depicted, the process begins when the content provider (the customer) 110 designs and creates mobile applications using a build-it-yourself development environment. In one embodiment, this development environment is provided through a website interface, which in turn utilizes a web service to enable the design and creation of the mobile applications. The website and web server may be hosted and operated by a third party provider or partner, or may be operating directly on the content provider's servers.

As depicted, the web service 120 packages the designed applications, and makes the applications available for distribution to mobile device users 130, or may even directly distribute the applications to the mobile device users 130. The various mobile applications created 140 may then be transmitted, installed, and operated on a plurality of mobile device platforms. As an example, these mobile device platforms include, but are not limited to, the Apple iPhone/iPad, Google Android, Windows Mobile, Windows CE, Palm OS, Blackberry, Symbian, Linux, and Java (such as J2ME) operating environments. The applications may then be installed on the mobile devices, used, and automatically updated as necessary.

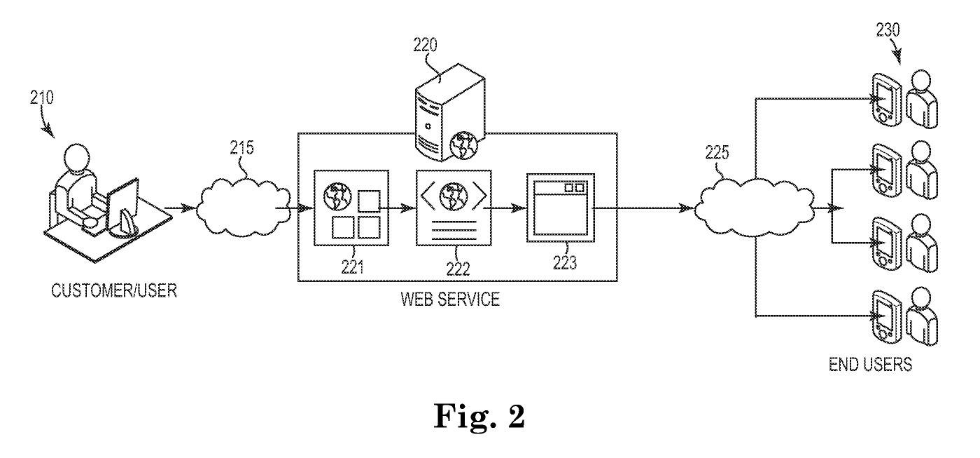

FIG. 2 provides further illustration of an example operation for designing and publishing a mobile application to various content customers in accordance with one embodiment of the present invention. First, a customer/content provider 210 designs and creates a mobile application on a development platform. As discussed above, this development platform may be hosted by a central company, a partner's labeled web site, or by the content provider themselves. As one example depicted in FIG. 2, customer 210 connects to a design website connected to a web service 220 through a network such as the internet 215. Various registration and/or authentication methods may be used to access the design website or the underlying web services 220.

The content provider applies templates 221 supplied on the website to select the structure of the application, including the navigation flow, the commands available within the application, and the like. The content provider further provides the content within the scope of design templates and the smartphone interface. As part of the design, a test or preview environment might be displayed to fully launch the mobile application in a simulated environment.

Once design is complete, the web service operates to package the various content and selected design templates into a native application usable by the mobile device. This includes creating XML or other internal data 222 specific for the application according to the design template 221. In this example, XML files containing data and binary files (such as images) are combined with the base application to create the installable application file 223 for each smartphone operating system. This executable application file 223 may then be deployed to mobile device end users 230 via a mobile communication network 225.

In this embodiment, the content provider's design is converted into an XML representation of the application layout. All visual elements created by the user through the design interface are represented and persisted in an internal native format. This format is translated into a defined XML representation, and is combined with any uploaded binary image files and any content data which is also represented in XML format. As a whole, the entire representation is termed a “data bundle”. A native base application for each targeted smartphone platform is then combined dynamically with the above-defined data bundle to create an installable application. All processes, including signing of the application, are performed dynamically and the targeted users are then informed (such as via email) about the availability of the installable application.

The mobile application that is created is structured to contain a number of components within this data bundle. The Application-specific components which make up a mobile deployment package include forms, settings and preferences, data sources, and images. As suggested above, the data sources are typically defined in XML format. Likewise, forms are XML representation of the various UI elements contained in each displayable page. Further included in the data bundle is XML data with commands that can either define navigation from one page to another, or execute smartphone specific commands like dialing a phone number, or send out an SMS or an email. The forms, data sources, images and other binary files of the data bundle are eventually combined into a device specific application when creating the installable smartphone app.

In one embodiment, metadata contained within the data bundle is largely semantic, with only minor amounts of presentation information. This is distinguishable from Adobe AIR or HTML-based implementations that provide far more visual/presentation instructions. Rather, with use of the data bundle, as much data as possible is directly provided to each platform, enabling a device to present the data in a manner that is consistent with that platform's functionality.

The use of “smart containers” containing these forms, data sources, and images dynamically provides a reconfigurable structure for the mobile application. A smart container provides the ability to host multiple applications without requiring another installation for every new version of the application. In this scenario, the smart container only requires the data bundles to be modified to change the format and contents of the application. The smart container itself is an installable application, but it understands how to present users the various data bundles which make up the individual application.

Additionally, the installable application may contain multiple applications within a single executable. Because the form of the program is entirely defined by smart containers and metadata, the native application can successfully contain multiple applications that may be distinctly operated and updated. As those skilled in the art would recognize, the multiple applications might originate from the same content provider or entirely different content providers.

In some embodiments, the native application is digitally signed as part of its creation, for use in smartphone environments which require digitally signed applications before execution. In other embodiments, the application is provided to a third party for signing. In the case of deployment to a BlackBerry device, signing keys and tools are provided by RIM (Research In Motion). Each installable application is signed using these keys on behalf of the application creator. This allows the application to use restricted functionality provided by the BlackBerry device.

In the case of deployment to an iPhone/iTouch/iPad device, the signed installable is provided to Apple for placement at the App Store. Once placed, users are directed to the App Store to download the application. For rare cases, where distribution through the App Store is not the preferred choice, adhoc distribution can be used. This requires the application designer to provide the unique identity codes for the individual iPhone/iTouch devices that will be running the application. These identifiers are included in the signing process, and therefore the application can be made available for immediate download, thus bypassing the app store.

The mobile application file is provided to users, such as via a link for download on a website, distributed via email or SMS directly to the mobile device, or is otherwise made available to the mobile device. The mobile device user may then access the link, open the email or the SMS message, or the like, and proceed with installation of the application on the smartphone.

Once the application is installed on the user's smartphone, the user may access the pre-designed application and any data contained therein. The application may be updated automatically or manually over the network as necessary. In various embodiments, this update may be performed at a predefined or specified interval, or the update may be manually initiated by the user, according to the update functionality described below.

Application Development Framework and Architecture

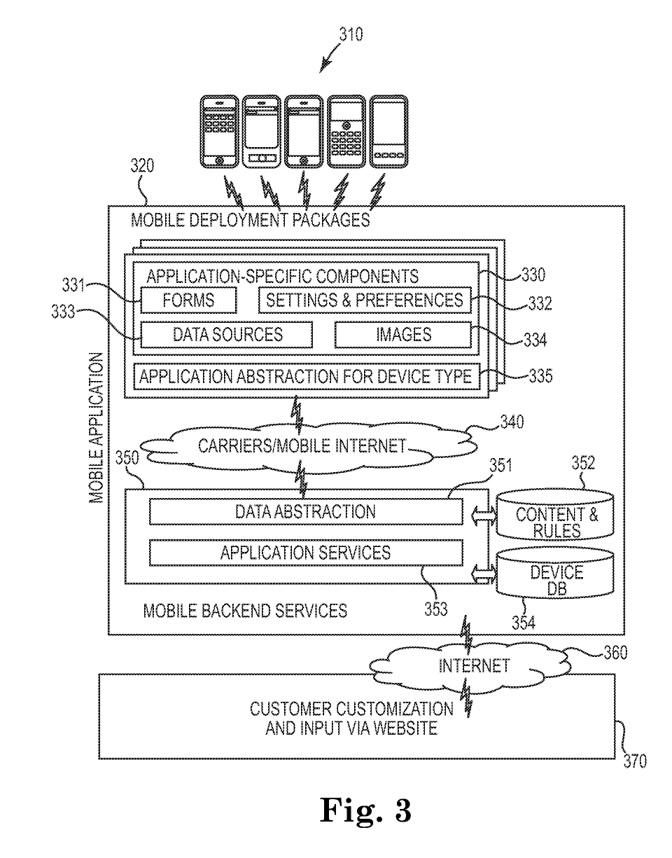

The development environment described above demonstrates the steps taken for design and distribution of the mobile application. FIG. 3 depicts, in additional detail, some of the underlying application framework and web service architecture 320 used to support creation and maintenance of a smartphone application according to one embodiment of the present invention.

As depicted, the customer or content provider 370 uses a development website or similar user interface, and may register or provide authentication details to access the development environment. Within the website, templates exist to provide an easy to use input and customization of both content and design. This website and any web services driving the website interface with various backend services 350 (typically connected via the internet 360) which create and maintain the mobile deployment packages 330.

Within the mobile backend services 350, a set of data abstraction data 351 and application services 353 is used to generate the data and data formats of the application user interface that may be is specific to the various mobile device types and operating systems. Information needed to generate the appropriate types of applications may be accessed through use of a content and rules data store 352, and a device information database 354.

Once the content provider user provides sufficient data, the web service operating on the server creates the mobile applications to be deployed to users of smartphone devices 310. Typically, these mobile applications will be deployed through mobile carriers or networks, or through internet connections. In one embodiment, the mobile application contains a set of XML files specific for the application as generated from the template. The XML files, along with user uploaded binary image files and optional data files, are combined with the base application executable—creating an application specific to the smartphone platform, generating each application for each smartphone operating system as appropriate. Therefore, at the conclusion of this process, an installable application file will be produced to be launched on mobile device 310.

Within the smartphone application itself, the application is divided into the following major components. A parser interprets each page layout XML and converts that into a native representative object through use of an application abstraction for a device type 335, e.g., a Java class on the Android, BlackBerry, Symbian platforms, a C# class on the Windows Mobile platform, or an Objective C class on the iPhone/iTouch/iPad platforms. The controller sequences the navigation commands and maintains a stack of displayable pages. A command executor executes platform specific commands like dialing a phone number or sending out an email. An updater brings in updated data content/layout forms and replaces existing ones and a data parser which is responsible for parsing the content XML and extracting data elements and placing them in the appropriate pages. A data submitter submits input gathered from the user and handles incoming requests. Each of these components together make up the base application.

For each targeted language/platform, a single base application 330 is created which is generic in nature and removed from the specifics of each device. For each device type 310, device and application specific components are created that plug into the base native application. The device and application specific components 330 are usually involved with the required elements for rendering of the pages, execution of commands, and the storage and retrieval of data.

Forms 331 serve as the representation of a page layout and are defined using XML. A platform generic schema is used to define various features for each type of display page. Embedded among the pages are navigational and/or executable commands. Images 334 are attributes of the pages and are embedded by names within each page, where relevant. Data sources 333 describe data content and are embedded within each form by name. Further in the form, descriptors are embedded which describe which data element of the data source are to be displayed in which part of the form.

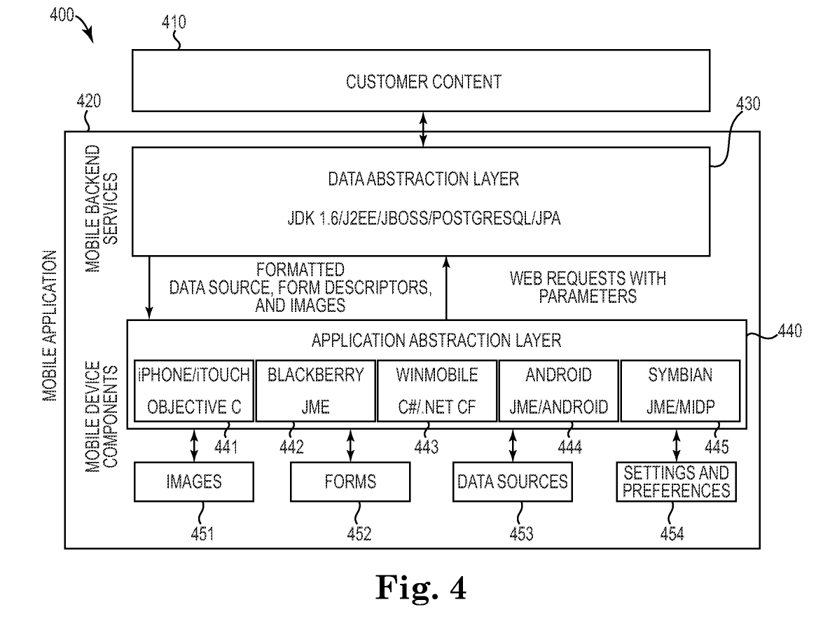

FIG. 4 depicts additional detail of an example mobile application development framework 400 in accordance with one embodiment of the present invention. As shown, the mobile application 420 is developed with relation to a number of components and services. The ultimate product that is produced for the customer contains the customer content within the mobile application. The customer content 410 is accordingly integrated with the mobile backend services through web services or other content-driven sources.

In one embodiment, the mobile backend services include a data abstraction layer 430. As is apparent, this configuration of a mobile application framework enables robust content solutions to be deployed. Summarized, the backend services provide the ability to compile data from other sources, and distribute new and updated data via the application to the customer.

The backend services may be configured to also act as a data collector/formatter/parser. For each application, the data collector may be programmed to gather data from various sources. The nature of the data and sources is specific to each application. The gathered data is further processed based on application-specific rules and retranslated into an application-specific format and then placed at a predefined location. During the next update process—whether manual or automated—this data is picked up by the application and presented to the user on the smartphone device.

Thus, the backend services may be configured to fetch customer data, images, and other information from the content provider's input and staged content. The backend services may then translate information into data sources, form descriptors, and images directly deployed within the mobile smartphone application. The backend services may comprise any combination of development tools and platforms. For example, in a Java development environment, the tools may include JDK 1.6, J2EE, JBoss, PostgresSQL, and JPA. Those of ordinary skill in the art would recognize that other development languages, platforms, and tools may be substituted to perform the role of the mobile backend services 430.

As an example of the type of backend services which can be configured to support a mobile application, a service can be configured to automatically retrieve and pull information data from another service operating on the internet, and repackage this data for use in the application. For example, timely data such as news, weather, or sports information might be pulled from a third party web service using web requests. This information can be formatted according to the requirements of the smartphone application interface and the hardware it executes on. Accordingly, the backend services can create data updates for the application consistent with the requirements and limitations of the mobile application.

The backend services are configured to enable smart updates of the application. The backend services are therefore also responsible for fully communicating information between the deployed application and any services as required. For example, the services can send information to the customer, such as usage data, updates, or may respond with specific data in response to a request by the customer.

As further shown in FIG. 4, numerous mobile device components may be included within the mobile application. As depicted, an application abstraction layer 440 is utilized to convert the specific types of content and data intended to be placed within the mobile application into the application itself. The components may be images 451, forms 452, data sources 453, and data associated with settings and preferences 454. These are converted into the specific environment and programming language as necessary.

As shown in FIG. 4, each mobile deployment package contains an application abstraction according to the smartphone device type. For example, the iPhone/iTouch application environment requires programming in Objective C 441; Blackberry in JME 442; Windows Mobile in C#/.NET CF 443; Google Android in JME/Android 444; and Symbian in JME/MIDP 445. The application framework operates to compile and build the application in a native language operable on the smartphone.

Those of ordinary skill in the art would recognize that the installable application file may take a variety of forms, consistent with the requirements of the mobile platform that the application will be launched upon. Additionally, the various locations of the application development components may be placed at different locations, in accordance with the capabilities and functionality of a properly configured development environment.

Additionally, those of ordinary skill in the art would recognize that a number of authentication techniques may be utilized with the communication of data between the deployed smartphone application and the backend services, and between the backend services and any external content providers and services. For example, a token, a cookie, or other type of a session identifier may be used to create and access a temporal session of varying length. This session may be used during one or more communications to secure data and/or remove the need for authentication.

Smartphone Application Interface

As a further illustration of how a typical application operates on a smartphone, the application itself on the smartphone loads forms, data sources, and images from local storage. Within the application, the application can request new images, data, and forms, as determined by user input, the data source, or the forms itself. The different forms display different information.

Therefore, the application design framework creates these components and translates them into the proper application abstraction and format. An application is made up of the data bundle along with the device specific code. In a particular embodiment, during startup, the application always looks for a named form, e.g., startup.xml. The contents of this form (“page”) allow user to navigate to other pages where images and data is displayed.

One of the pages may execute an update command which in turn will gather replacement or additional images, data and forms from data feeds. These contents are persisted into the device store. Upon requests to fetch the data source, image or form, the device store is first checked for presence of the requested content. If available, the content is served up within the application, thus allowing a new image, data source or form to be displayed. Further, as discussed above, these data feeds may contain content data as well as application modifiers. Content data simply provides the contents that need to be displayed. Modifiers actually provide a new shape to the application so the application behavior and/or look and feel can change dynamically.

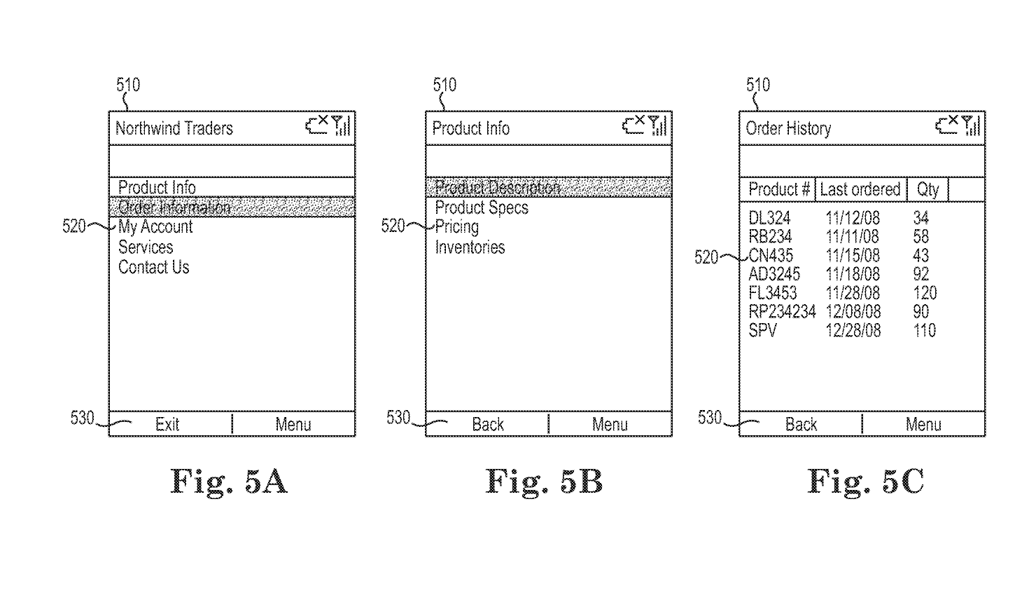

FIGS. 5A-5C depict screenshots of an example application operating on a smartphone developed with an application development framework in accordance with one embodiment of the present invention. As shown in FIG. 5A, an introductory interface to a custom application 510 provides navigable options in the main screen 520, along with a menu option and an exit option tied to specific smartphone keys or buttons. FIG. 5B demonstrates another interface screen accessed through the selection of a category from the main screen, itself presenting another list of choices. FIG. 5C depicts a list of product data consistent with the application.

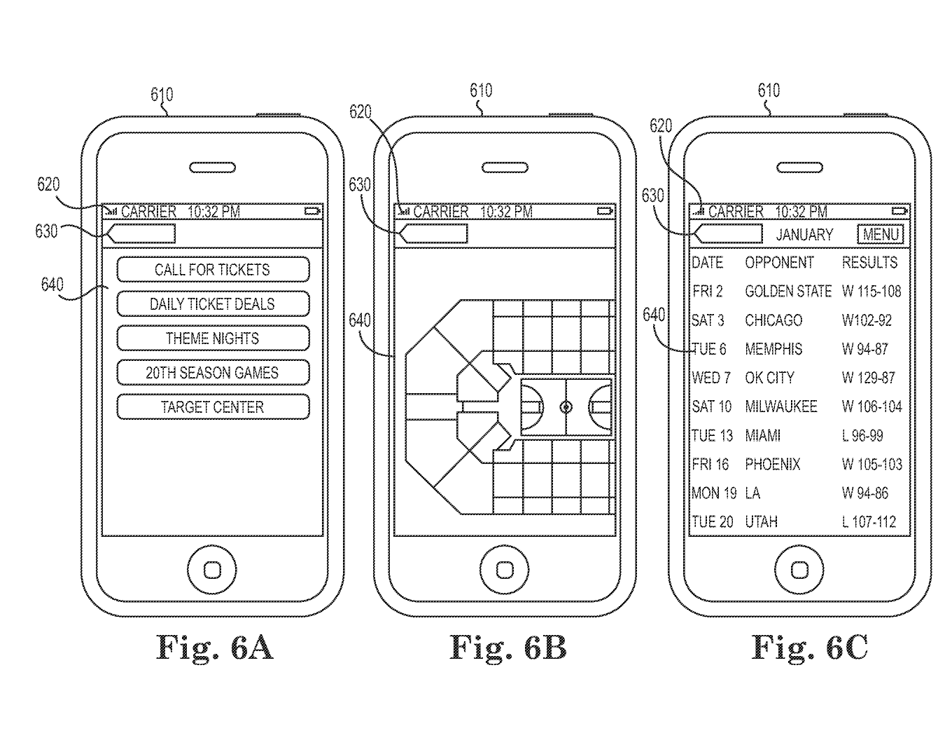

FIGS. 6A-6C depict screenshots of an example application operating on a touchscreen smartphone 610 developed with an application development framework in accordance with one embodiment of the present invention. The screen in FIG. 6A illustrates a list of buttons 640 selectable on the smartphone touchscreen within the smartphone application. For example, one of the options is to initiate a phone call. Those of ordinary skill in the art would recognize that the applications developed for the smartphone platform may be designed to integrate with existing technology and features of the phone and phone user interface 620, such as phone call functions, audio functions, internet connectivity, GPS, and the like. Other typical application user interface features such as navigation and menu options 630 may also be presented within the smartphone application.

The screen in FIG. 6B depicts the display of a data image 640 accompanying the application. In this case, a seating map image is displayed on the smartphone, which may be scaled, moved, zoomed, etc., within the application display consistent with the image display functions of the device. FIG. 6C depicts a display of textual data 640 within the application. In this case, as scores become available and the schedule changes, the data within the display can be updated.

In one embodiment, the application user interface that operates on the smartphone may also be generated and displayed in a mobile web page format. This format may be accessible via the internet or a mobile communication network, or packaged and distributed to smartphones directly. Providing a user interface for mobile browsers enables unsupported smartphones to gain access to substantially the same content and design as the deployed mobile applications.

Tracking Capabilities

Further embodiments of the present invention enable tracking functionality. Activities such as installations, updates, and requests for specific data or activities may be tracked within the smartphone. Each application is granted a unique identifier. Upon any update or input request, this identifier along with any device unique identification is submitted to the back end servers. This identification tuple serves as a tracking mechanism. Items tracked may include number of updates, type of interaction, number of application downloads, and the like.

Input Capabilities

The application may also include inputs that can be fed to defined targets. The information can then be downloaded during subsequent communications. In one embodiment, application generated inputs are used to create an HTTP or HTTPS request. The destination URI which will receive these requests is embedded within the forms (pages') which are used to describe the input controls. The request is submitted to the defined URI and a specific type of response is expected.

The response may include pre-defined codes and one or more results. The results may contain information in the form of key-value pairs or actual forms, images or data sources. Based on the result type, the application will take appropriate action. In case of codes, the user may be redirected to a particular form. If the result type contains forms/images/data sources, the data is written to the device and is used later during subsequent navigation process.

Update Capabilities

Update functions can occur either on demand or as a background process operating at a specified periodicity. The need of the update function is application-dependent. In case of manual update, the application designer designs an update form. Navigating to this form automatically triggers an update. The update form contains a URI which is visited by the update process. In case of background update, at the scheduled period, the defined URI is visited. In either case of update, the response retrieved from the URI contains forms/images/data sources which are persisted in the device store. These forms/images/data sources can be used to create or update any of the forms/images/data sources (including the update form itself) that previously existed within the application data bundle. Therefore, small portions or even the entire application can be redesigned and changed on the smartphone device with an update function.

Additionally, in a further embodiment, the backend services providing the updated content keep track of when each of the applications last updates its content. This enables the mobile application to obtain only the newest content when updating, rather than having to unnecessarily download the all content of the application. Further, a content provider or content system may determine how often updates occur, or be alerted if a large number of devices have not obtained updates to the data.

Those of ordinary skill in the art will recognize that the various mobile applications described above may be enhanced by various degrees of internet connectivity. Therefore, some applications may be configured to only utilize data contained in the original application download, whereas other applications may receive data on an updated or realtime basis, or the application may provide various requests for additional data to a supporting mobile backend service.

As will be appreciated by one of ordinary skill in the art, the various aspects of the present invention may be embodied as a system, method, or computer program product. Accordingly, the embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: a portable computer diskette, a hard disk, random access memory (RAM), read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. A computer-usable or computer-readable medium may be any medium that can contain, store, communicate, propagate, or transport the program for use by or in connection with the instruction execution system, apparatus, or device. The computer usable program code may be transmitted using any appropriate medium, including, but not limited to wireless, wireline, optical fiber cable, RF, broadband and narrowband mediums, etc.

Additionally, those of ordinary skill in the art will recognize that the mobile computing devices described in the present disclosure are provided as examples, and that the presently disclosed methods, systems, and computer program products would also include the use of a variety of portable computing devices such as smartphones, netbook computers, notebook computers, e-book devices and e-readers, tablets and portable computing platforms such as the iPad, touch screen electronics, and other devices that access and/or download discrete applications.

Computer program code for carrying out operations of the present invention may be written in any combination of one or more programming languages, including an object oriented programming language such as .NET, Java, Objective-C, Smalltalk, C++ and the like and conventional procedural programming languages, such as the “C” programming language or similar programming languages. The program code may execute entirely on processors or other suitable components within the user's computing device, partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN), wireless network, or a wide area network (WAN), or the connection may be made to an external computer (for example, through the Internet using an Internet Service Provider).

The various embodiments of present invention are described above with reference to flowchart illustrations and/or block diagrams of methods, apparatus (systems) and computer program products according to embodiments of the invention. Each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and illustrations in the Figures illustrate the architecture, functionality, and operation of possible implementations of systems, methods, and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various representative embodiments of this invention have been described above with a certain degree of particularity, those of ordinary skill in the art could make numerous alterations to the disclosed embodiments without departing from the spirit or scope of the inventive subject matter set forth in this application.

What is claimed is:

1. A method for deploying and updating software applications on mobile computing devices, comprising:
creating design and content of a software application user interface for deployment to a plurality of mobile computing devices;
converting the design and content into a data package, the data package including XML and binary data representing the design and content for the software application user interface;
integrating the data package into a native software application executable within a mobile computing device operating system to embody the software application user interface in a format native to an operating system of the mobile computing device;
deploying the native software application to a mobile computing device for installation and execution, the mobile computing device being enabled to install and execute the native software application within the mobile computing device operating system;
creating an update to the design and content of the software application user interface by updating the XML or binary data within the data package; and
deploying the update to the mobile computing device by updating the data package within the native software application, thereby updating the design and content of the software application user interface within the native application without reinstallation of the native application on the mobile computing device.

2. The method of claim 1, wherein the data package is integrated into a plurality of mobile computing device platforms for installation and execution on a plurality of mobile computing devices having distinct mobile computing device operating systems.

3. The method of claim 1, wherein the mobile computing device operating system is one of an Android, Blackberry, iPhone, iTouch, iPad, or Windows Mobile operating system.

4. The method of claim 1, further comprising obtaining a digital signature for the native software application and signing the native software application prior to deploying the native software application to the mobile computing device.

5. The method of claim 1, wherein the update is initiated in response to a user request initiated within the native software application.

6. The method of claim 1, wherein the update is automatically deployed to the native software application responsive to creation of the update of the design and content.

7. The method of claim 1, wherein the update is deployed to the mobile computing device through use of a mobile communications network.

8. The method of claim 1, wherein the update is deployed to the mobile computing device through use of an internet connection.

9. The method of claim 1, wherein a remotely accessible web service is used to create, convert, and update the design and content of the software application user interface into the data package.

10. The method of claim 1, wherein the XML includes forms, settings and preferences, and data sources embodied within the software application user interface, and wherein the binary data includes images embodied within the software application user interface.

11. A system, comprising:
a mobile communications network;
a plurality of mobile computing devices;
a mobile application development computing system, the mobile application development computing system including instructions for deploying and updating software applications on the mobile computing devices, and the instructions being executed on a plurality of hardware components within the mobile application development computing system for:
creating design and content of a software application user interface for deployment to the plurality of mobile computing devices;
converting the design and content into a data package, the data package including XML and binary data representing the design and content for the software application user interface;
integrating the data package into a native software application executable within a mobile computing device operating system to embody the software application user interface in a format native to an operating system of the mobile computing device;
deploying the native software application to one of the plurality of mobile computing devices for installation and execution, the mobile computing device being enabled to install and execute the native software application within the mobile computing device operating system;
creating an update to the design and content of the software application user interface by updating the XML or binary data within the data package; and
deploying the update to the mobile computing device by updating the data package within the native software application, thereby updating the design and content of the software application user interface within the native application without reinstallation of the native application on the mobile computing device.

12. The system of claim 10, wherein the data package is integrated into a plurality of mobile computing device platforms for installation and execution on a plurality of mobile computing devices having distinct mobile computing device operating systems.

13. The system of claim 10, wherein the mobile computing device operating system is one of an Android, Blackberry, iPhone, iTouch, iPad, or Windows Mobile operating system.

14. The system of claim 10, further comprising instructions for obtaining a digital signature for the native software application and signing the native software application prior to deploying the native software application to the mobile computing device.

15. The system of claim 10, wherein the update is initiated in response to a user request initiated within the native software application.

16. The system of claim 10, wherein the update is automatically deployed to the native software application responsive to creation of the update of the design and content.

17. The system of claim 10, wherein the update is deployed to the mobile computing device through use of the mobile communications network.

18. The system of claim 10, wherein the update is deployed to the mobile computing device through use of an internet connection.

19. The system of claim 10, wherein a remotely accessible web service is used to create, convert, and update the design and content of the software application user interface into the data package.

20. The system of claim 10, wherein the XML includes forms, settings and preferences, and data sources embodied within the software application user interface, and wherein the binary data includes images embodied within the software application user interface.
